(19) United States
(12) Patent Application Publication
(10) Pub. No.: US 2017/0193783 A1
(43) Pub. Date: Jul. 6, 2017

(54) Alarm System with Remote Repelling Effects

(71) Applicant: Michael Soderman, Berlin (DE)

(72) Inventor: Michael Soderman, Berlin (DE)

(21) Appl. No.: 14/986,735

(22) Filed: Jan. 4, 2016

(51) Int. Cl. G08B 15/00

(52) U.S. Cl. CPC G08B 15/00

(57) ABSTRACT

The invention relates to an alarm system for repelling intruders, comprising a detector, a transmitter, a receiver and an output device with pre-established content, whose non-siren output creates audio, visual, olfactory, tactile or motion-related effects to immediately drive intruders away. The output device can be located in a different room or part of the house and can be linked to the detector via wiring or via a wireless link. Content that is produced in a different location can depend upon the location of the entry or breakin. The output device can be further controlled via a control unit attached to the E input of the flip-flop, and a disguised or concealed lever or switch can enable an easy shutdown of the alarm system.

### BACKGROUND

The invention relates to an alarm system with remote effects to drive away burglars or intruders.

Security systems are typically implemented by either wired or wireless sensors in the property being protected. These sensors may be comprised of door contacts, window contacts, glass-break detectors, motion sensors, and other types of intrusion detection sensors, as well as other environmental sensors like smoke, fire, carbon monoxide, and flood sensors. When a sensor is tripped, the system may sound a local siren, or notify an offsite host station of the event, or both. Depending on the type of sensor tripped, the system may wait for a period before sounding the alarm or notifying the host station so that the property owner or manager will have an opportunity to disarm the system.

Some security systems provide for further indicator signals, in addition to a local siren or a notification of a monitoring service, the police or other personnel. U.S. Pat. No. 4,833,449, as an example, describes a flashing of exterior lights on a protected home to warn persons of the possible presence of an intruder in the home. Security systems also use wireless links for various reasons, for instance to provide overlapping detection means without wire connections, as described in U.S. Pat. No. 4,363,031.

The common problem is that a remote alarm to a monitoring station will not immediately drive out any burglars/ intruders, and it may take some time for the police or security personnel to arrive at a burglary or intrusion scene. A local alarm may not immediately repel burglars either, for instance because they may feel, particularly in rural areas, that they have a bit of time before security personnel or the police arrive, that they can very quickly disable the local alarm (the source of a loud alarm immediately becomes clear), or that people may have become accustomed to an alarm (this is familiar in the case of car alarms that are frequently triggered and frequently ignored).

### SUMMARY

The invention relates to an alarm system for repelling intruders, comprising a detector, a transmitter, a receiver and an output device with pre-established content, whose non-siren output creates audio, visual, olfactory, tactile or motion-related effects to immediately drive intruders away. The output device can be located in a different room or part of the house and can be linked to the detector via wiring or via a wireless link. Content that is produced in a different location can depend upon the location of the entry or break-in. The output device can be further controlled via a control unit attached to the E input of the flip-flop, and a disguised or concealed lever or switch can enable an easy shutdown of the alarm system.

### DETAILED DESCRIPTION

The object of the invention is to create a wire-based or wireless alarm system comprised of at least one detector and transmitter and at least one receiver and output device that discourages and drives away intruders with local events in ways other than using a local shrill alarm. These events can include audio, visual, olfactory, tactile or motion-related effects, among others. A burglar/intruder may still take the time to steal objects when there is a local alarm, but may want to immediately get out of the building when there seems to be an immediate threat or disorienting action, and non-siren effects can naturally also be combined with a silent alarm to a monitoring station/police and the like.

A receiver and output device can be located in a different place or room than the detector and transmitter. This has the advantage that a command can be issued by the detector and transmitter to the receiver and output device at a different location, and the output device can continue operation even if the detector and transmitter are discovered by, and disabled or destroyed by, intruders.

A wide range of effects can be used to drive intruders away. With regard to audio effects, as examples, the low-pitched growling of an apparently big dog could be heard coming from a different room, or the sound of a gun being racked or cocked or a shotgun being pumped could also be heard. Whispering speech, depending on the content, could also be effective, including speech apparently from security guards or the police.

Visual effects can include sudden bright lights or flashes, red laser dots like those coming from laser sights of guns—with no clear source, effectively placed shadow effects or a face or other image that suddenly seems to be watching through a window.

Other effects could include sudden, unexplained movements of objects, unusual tactile events or extremely unpleasant odors. Effects can, of course, be tailored to the type of building, the type of break-ins that occur in the surrounding area and the expected motivations of burglars and intruders. Amateur burglars and young people who want to have an impromptu party location or who want to engage in vandalism or the like can, in some cases, be quickly and easily scared away by certain events or effects.

The location of entry may also determine the content that is initiated. As examples, entry through a window in a bedroom may initiate the sound of the front door opening, and entry through the front door may initiate the sound of a deep-pitched dog growl in the bedroom or the sound of a gun being cocked or racked.

In one embodiment, a combined device comprising a detector and transmitter, on the one hand, and a receiver, control unit and output device, on the other hand, can be installed in multiple rooms. The detector and transmitter of each combined device would communicate via a wireless link with the receiver, control unit and output device of each of the other combined devices. One or more of the control units in the other combined devices would initiate effects in one or more of the other combined devices when an alarm message is received. The response to the alarm message could include multiple coordinated effects coming from different places or rooms and also coordinated serial effects that follow one another chronologically.

The control unit can be as simple as a remotely triggered switch that turns the output device on or off, or it could be a microprocessor, for instance, that controls various events in terms of both place and time. The detector side can also have an easy shutoff switch for the owner that could simply be a concealed or disguised lever or switch or the like that instantly shuts the system down. The switch could also be included in what appears to be a household item that is not related to an alarm system, for instance a TV remote control. The shutoff switch could also simply be a matrix of buttons, possibly disguised as part of a different non-alarm device, and only one button has to be pressed to shut the system off, not a code. The requirements for the shutoff switch would be different than those for an alarm system with a shrill siren. In the case of apparent non-alarm noises from a different room, for instance, an intruder may have no idea that the content is based on an alarm system. If the person entering the building knows that the content is alarm-related, the need for a complicated code or the like to disarm the system is eliminated anyway.

The input E of the flip-flop on the receiver side can be kept at ground to enable the flip-flop to change states based on the input at D, or the input E can be brought up to a logical “1” to keep the flip-flop in the present state. Simple circuitry or a microprocessor could therefore also be used to determine based on a given situation whether the flip-flop, and thus the on/off status of the output device, is to be kept in a certain state or made responsive to the input from the detectors.

### BRIEF DESCRIPTION OF THE DRAWINGS

The following are shown in the accompanying drawings:

FIG. 1 shows a basic block diagram of the alarm system, comprising a detector, a transmitter, a link, a receiver, a control unit and an output device;

FIG. 2 shows a basic diagram of an embodiment of the detector and transmitter;

FIG. 3 shows a basic diagram of an embodiment of the receiver, control unit and output device;

FIG. 4 shows a circuit diagram of an embodiment of the detector and transmitter;

FIG. 5 shows a circuit diagram of an embodiment of the receiver, control unit and output device;

FIG. 6 shows a logic diagram of an embodiment of the latching flip-flop;

FIG. 7 shows a basic diagram of a shut-off switch included on the detector and transmitter side; and

FIG. 8 shows a control unit for the flip-flop to enable back-and-forth switching or to latch it into a particular state.

Functionally equivalent components have been given the same reference numeral in all of the figures.

### DETAILED DESCRIPTION OF THE PREFERRED EMBODIMENT

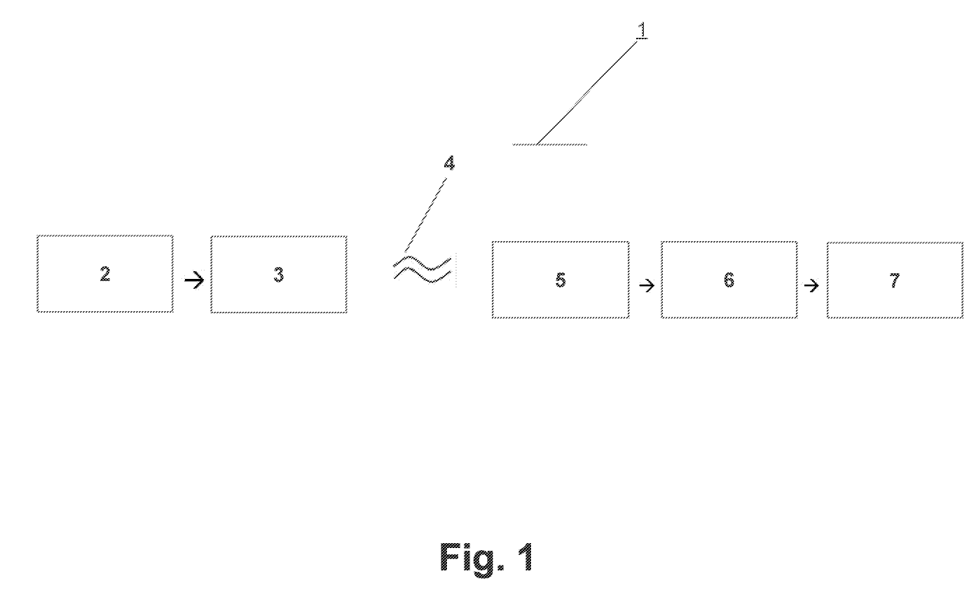

The basic principle of a simple embodiment of the invention is shown in FIG. 1. The detector 2 could be as simple as a pair of metal contacts that make contact, thus completing the circuit, or that release contact when a door or window is closed or opened. Commercial sensors with diverse input types are naturally also available in many different configurations and designs. The transmitter 3 essentially passes the data from the detector 2 further along to the receiving side. If a wire is used instead of a wireless link, the transmitter could be as simple as the wire transmitting the data. The transmitter 3 in the example described here is an amplitude shift keying transmitter. This type of transmitter can send along binary information (open or closed circuit, for instance) via a wireless link in a very simple way.

After the information is sent, a receiver 5 receives the data. Analogously to the wire in a wire-based transmission system acting as a transmitter, the wire can also act as the receiver. The receiver 5 in the example described here is an amplitude shift keying receiver. The information can then be sent along to a control unit 6 or directly to an output device 7. The output device has pre-established content, meaning some type of content involving audio, visual, olfactory, tactile or motion-related effects to immediately drive intruders away. An example here is an MP3 player with pre-recorded audio content that outputs sound to a loudspeaker. The MP3 player could be in a different room, and could produce sounds like dog growling or a gun being cocked or loaded. Any type of unexpected and unexplained sound may frighten certain types of intruders away.

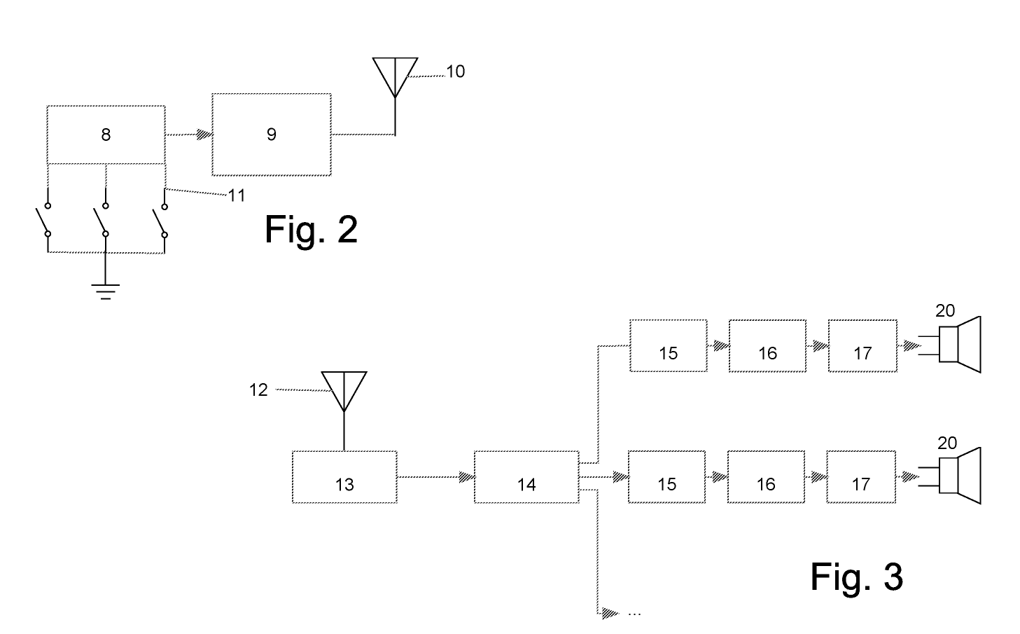

The transmitting side is broken out a bit more in FIG. 2. Contact/no-contact switches send information to an encoder 8, which sends the information to an amplitude shift keying transmitter 9 for transmission. This takes place in this example through the sending antenna 10.

A bit more detail of an embodiment of the receiving side is shown in FIG. 3. The binary information is received by the receiving antenna 12 and sent to the amplitude shift keying receiver 13. The ASK receiver sends the information along to the decoder 14. The decoder breaks out the information, for instance respectively with regard to the switches that input the information, to various output lines. Each output line is comprised here of a flip-flop 15, which sets the desired on/off value, an on/off switch 16 that does the actual switching, an MP3 player 17 in the example described here, and a loudspeaker 20 to convert the signals from the MP3 player 17 into realistic sounds.

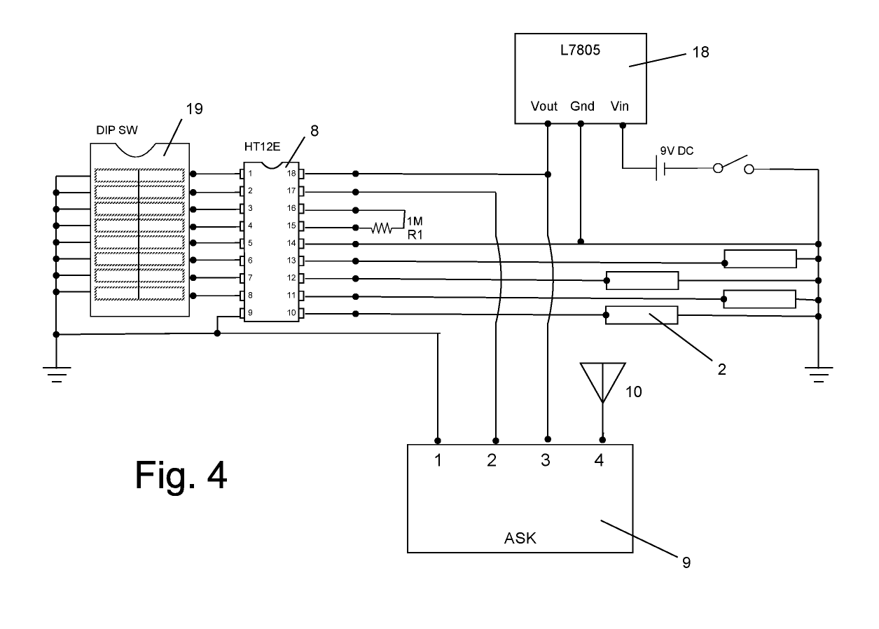

FIG. 4 shows a circuit diagram of an embodiment of the transmitting side. The detectors 2 start the chain of information by detecting whether a door or window in the building has been opened, for instance. The information is sent to an encoder 8, which could be an HT12E chip produced by the company Holtek, for instance. A DIP switch 19 can be attached to the encoder chip to modify settings; in this example, the switches on the transmitting side should have the same positions as the switches on the receiving side. A regulated power supply 18 provides the electrical power for the transmitting side, and this could be an L7805 chip manufactured by the company STMicroelectronics, Inc., as an example.

The encoded information is then sent to an amplitude shift keying transmitter 9 and then wirelessly sent via a sending antenna 10. The amplitude shift keying transmitter 9 is a generic 433 MHz ASK transmitter in this example.

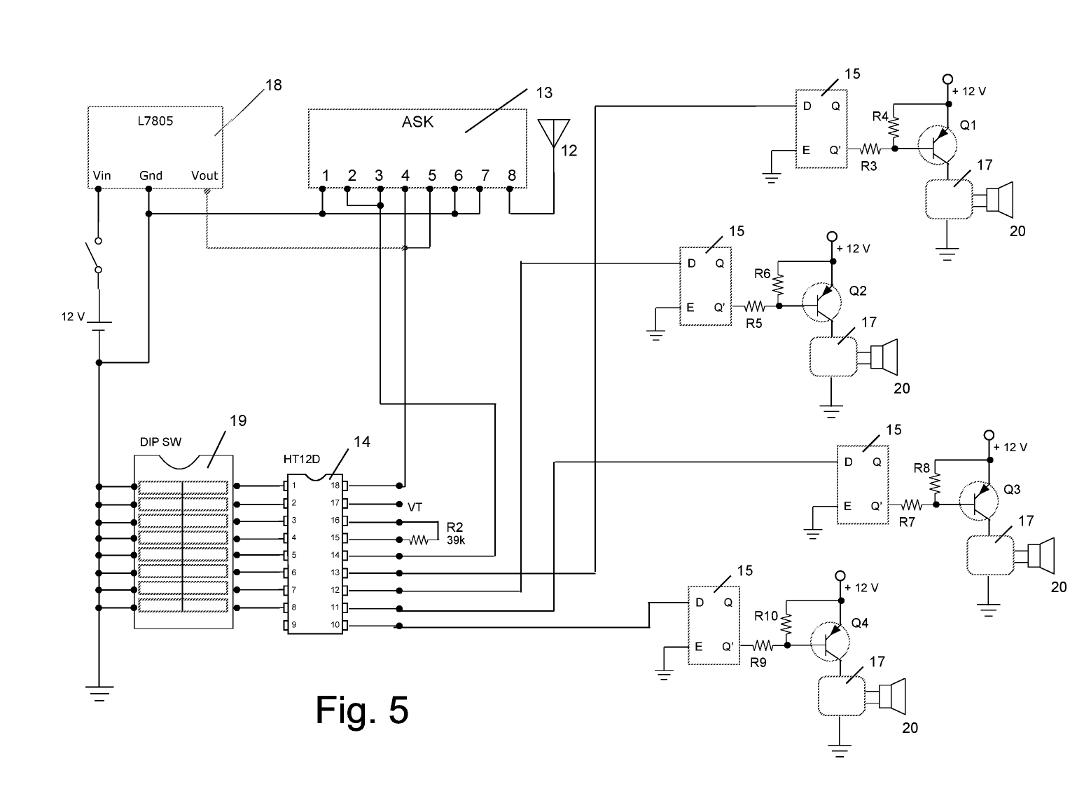

A circuit diagram of an embodiment of the receiving side is shown in FIG. 5. The binary information is received by the receiving antenna 12 and sent along to the amplitude shift keying receiver 13. The ASK receiver in this example is a generic 433 MHz ASK receiver. The data is then sent to a decoder 14, which could be an HT12D chip produced by the company Holtek, as an example. A DIP switch 19 can be attached to the decoder chip to modify settings; in this example, the switches on the receiving side should have the same positions as the switches on the transmitting side. A regulated power supply 18 provides the electrical power for the transmitting side, and this could be an L7805 chip manufactured by the company STMicroelectronics, Inc., as an example.

The decoder 14 breaks the information out to various output lines depending on the detector providing the input on the transmitting side. Each output line in this example is comprised of a flip-flop 15, which sets the desired on/off value, a transistor Q1-Q4 acting as an on/off switch, an MP3 player 17 in the example described here, and a loudspeaker 20 to convert the signals from the MP3 player 17 into realistic sounds.

The “E” terminal of the flip-flop 15 in this embodiment is connected to ground, which enables the flip-flop 15 to change state depending on the input that ultimate comes from the relevant detector 2. A control unit 24 for the flip-flop could alternatively be connected to the “E” terminal to determine whether the flip-flop 15 will change state according to the detector 2 input (ground, logical “0”) or whether it will be latched into its current state (logical “1”). The output is sent to a unit to switch the MP3 player on and off, comprised of a general PNP transistor and resistors. The resistors R3-R4, R5-R6, R7-R8 and R9-R10 can have value pairs of 10 k ohms and, for instance, 100 k ohms, respectively. The resistors R4, R6, R8 and R10 are not absolutely necessary, but they provide stability and the assurance of a complete shutoff on the part of the transistor. The MP3 player 17 and loudspeaker 20 can be any kind of commercially available units. The input voltage/ battery input to the MP3 player 17 may have to be changed to fit the specific player, of course, and further driver/amplifiers could also be used for output to the loudspeaker.

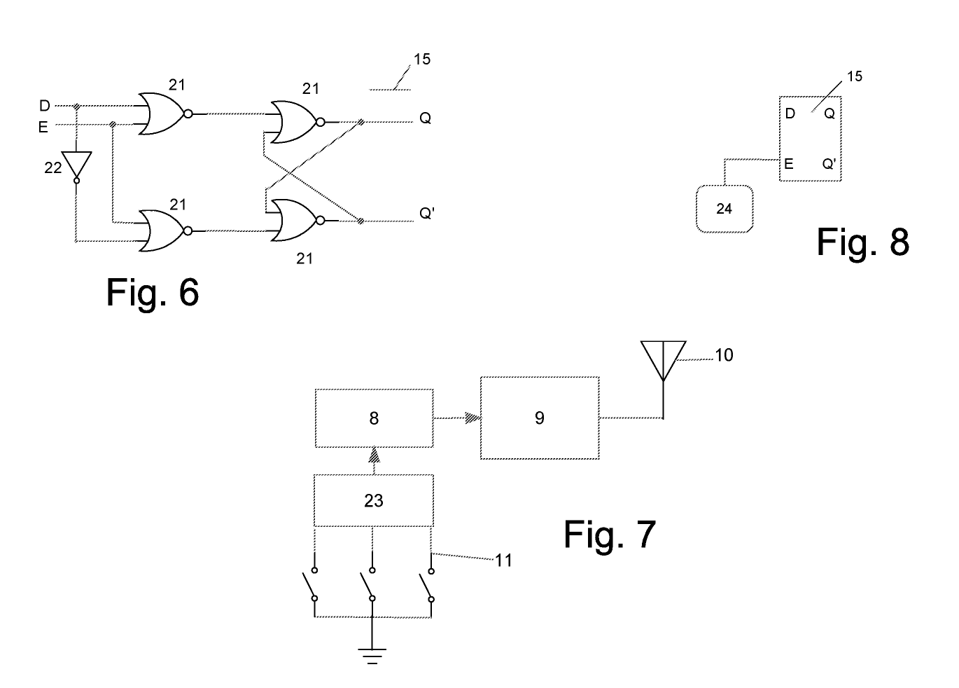

An embodiment of the flip-flop 15 is shown in terms of a logical diagram in FIG. 6. The flip-flop 15 in this embodiment is comprised of NOR gates and an inverter. “D” is the input and can determine/set the state of the flip-flop 15. “E” determines whether the flip-flop 15 will be latched or not. When “E” is at ground, the flip-flop 15 will change state depending upon the input “D”. When at logical “1”, the input “E” will latch the flip-flop 15 in its current state. “Q” is the output, and “Q′” is the inverse of the output “Q”.

FIG. 7 shows a reset/shutoff unit 23 between the input switches/detectors and the rest of the transmitting side of the embodiment shown in previous figures. Since this embodiment of the invention is based on scaring away an intruder by means other than a shrill alarm, where it is clear that an alarm system is present, the reset/shutoff unit 23 for the owner of the house, or an authorized person with knowledge of the unit, could also be a concealed switch or a switching device disguised as something else. There could, of course be a concealed or disguised switch for the embodiment of this invention and a more conventional shutoff unit with a code for an alarm system that contacts a monitoring office or the police, for instance. The reset/shutoff unit 23 could be concealed in household objects or disguised as a television remote control or the like. The unit could also be a matrix of buttons, apparently for some other purpose, and a single button in the matrix has to be pushed instead of a code.

A control unit 24 for the flip-flop is shown in FIG. 8. The control unit 24 could be a circuit or microprocessor that sets the input “E” to logical “1” or “0” (ground) based on other inputs in the system. The output device 7 can then be held in a particular state, on or off, when there is a reason to do so, or it could be opened to switching on or off depending upon the input to “D” of the flip-flop 15.

### LIST OF REFERENCE NUMERALS

1 Alarm system
2 Detector
3 Transmitter
4 Link, wire-based or wireless
5 Receiver
6 Control unit
7 Output device
8 Encoder
9 Amplitude shift keying transmitter
10 Sending antenna
11 Triggering switch
12 Receiving antenna
13 Amplitude shift keying receiver
14 Decoder
15 Flip-flop
16 On/off switch
17 MP3 player
18 Regulated power supply
19 DIP switch
20 Loudspeaker
21 NOR gate
22 Inverter
23 Reset/shutoff unit
24 Control unit for the flip-flop
R1-R10 Resistors
Q1-Q4 Transistors

1. An alarm system for repelling intruders, comprising a detector, a transmitter, a receiver and an output device with pre-established content, whose non-siren output creates audio, visual, olfactory, tactile or motion-related effects to immediately repel an intruder.

2. The alarm system according to claim 1, wherein a control unit receives data from the receiver and sends data to the output device to select, coordinate and chronologically initiate non-siren output.

3. The alarm system according to claim 1, wherein combined devices, each comprised of the detector, the transmitter, the receiver and the output device, are installed in different places or rooms in a building.

4. The alarm system according to claim 3, wherein each combined device includes a control unit that receives data from the receiver and transmits control data to the output device.

5. The alarm system according to claim 1, wherein the output device comprises an MP3 player with pre-recorded content to immediate repel the intruder and also comprises a loudspeaker.

6. The alarm system according to claim 5, wherein the pre-recorded content is a gun being cocked or loaded.

7. The alarm system according to claim 5, wherein the pre-recorded content is deep growling of a dog.

8. The alarm system according to claim 1, wherein the output device with pre-established content creates sudden intense light flashes in a room in which the intruder is located.

9. The alarm system according to claim 2, wherein the control unit includes a flip-flop.

10. The alarm system according to claim 9, wherein the flip-flop can be shifted back and forth between a latched state and a state in which an input signal determines an output signal via a control unit for the flip-flop.

11. The alarm system according to claim 1, wherein a reset/shutoff unit is included between the detector and the transmitter.

12. The alarm system according to claim 11, wherein the reset/shutoff unit is designed to look like a customary household item not related to the alarm system.

13. The alarm system according to claim 11, wherein the reset/shutoff unit appears to be a remote control unit for a television.

14. The alarm system according to claim 11, wherein the reset/shutoff unit comprises a matrix of buttons, and a single button has to be pressed to shut the alarm system down.
